(19) United States
(12) Patent Application Publication
(10) Pub. No.: US 2008/0211789 A1
(43) Pub. Date: Sep. 4, 2008

(54) PLASMA DISPLAY APPARATUS

(76) Inventor: Jin Boo Son, Suwon-si (KR)

Correspondence Address: CHRISTIE, PARKER & HALE, LLP, PO BOX 7068, PASADENA, CA, 91109-7068, US

(21) Appl. No.: 11/940,259

(22) Filed: Nov. 14, 2007

(30) Foreign Application Priority Data
Nov. 23, 2006 (KR) 10-2006-0116343

(51) Int. Cl. G06F 3/038; G09G 3/28

(52) U.S. Cl. 345/204; 345/60; 315/169.4

(57) ABSTRACT

A plasma display apparatus includes a display panel including scan electrodes and sustain electrodes; a selection circuit connected to a corresponding one of the scan electrodes, and selectively applies first and second voltages to the corresponding scan electrode; an energy recovery circuit connected to a sustain voltage source for supplying a sustain voltage and the selection circuit, the energy recovery circuit supplies a sustain pulse to the scan electrodes; and drivers connected to the selection circuit and supply rising and falling ramp signals and a scan signal to the scan electrodes. The energy recovery circuit includes a first transistor for providing an operating voltage to the selection circuit; a second transistor for providing the sustain voltage to the selection circuit; and a control transistor located between the second transistor and the first transistor, wherein the control transistor controls a flow of electrical current from the energy recovery circuit.

### CROSS-REFERENCE TO RELATED APPLICATIONS

This application claims priority to and the benefit of Korean Patent Application No. 10-2006-0116343, filed on Nov. 23, 2006, in the Korean Intellectual Property Office, the entire content of which is incorporated herein by reference.

### BACKGROUND

1. Field of the Invention

The present invention relates to a plasma display apparatus, and more particularly to a plasma display apparatus having a driving circuit.

2. Discussion of Related Art

Scan electrodes and sustain electrodes are formed on an upper substrate of a plasma display apparatus, and address electrodes are formed in a direction perpendicular to the scan electrodes and the sustain electrodes on a lower substrate which is disposed opposite to the upper substrate.

One frame of the plasma display apparatus is divided into a plurality of subfields, each subfield having a predetermined weight, and the subfields are driven to display an image during one frame. Each of the subfields is composed of three parts: a reset period, an address period and a sustain period.

A wall charge is formed by supplying a ramp pulse (or ramp signal) to the scan electrodes during the reset period, followed by stably generating an address discharge. A scan pulse (or scan signal) is sequentially supplied to the scan electrodes and a data pulse (or data signal) is supplied to the address electrodes during the address period. Then, an address discharge is generated at discharge cells to which the data pulse has been supplied to form the wall charge.

A sustain pulse is alternately supplied to the scan electrodes and the sustain electrodes during the sustain period to generate a sustain discharge at the discharge cells selected by the address discharge. Here, an image having a luminance is displayed in a panel in accordance with the number of sustain discharges that are generated.

The conventional plasma display apparatus as described above is provided with a scan driver for supplying a driving waveform (e.g., a predetermined driving waveform) to the scan electrodes.

FIG. 1 is a circuit diagram showing a conventional scan driver. A panel capacitor (Cp) equivalently represents capacitive components formed by a scan electrode (Y) and a sustain electrode (X), as shown in FIG. 1. Also, the sustain electrode (X) is typically connected with a sustain driver (not shown), but the sustain electrode (X) is shown as being connected with a ground voltage source (GND) for convenience of description.

Referring to FIG. 1, the conventional scan driver includes a respective selection circuit 110 connected to each of the scan electrodes (Y); a first driver 102 for supplying a rising ramp pulse (i.e., a rising ramp signal); a second driver 106 for supplying a falling ramp pulse (i.e., a falling ramp signal) and a scan pulse (i.e., a scan signal); and an energy recovery circuit 104 for recovering and re-supplying an energy of the panel capacitor (Cp).

The respective selection circuit 110 is connected to each of the scan electrodes (Y). The selection circuit 110 controls a driving waveform (a driving voltage) supplied to the scan electrodes (Y) by controlling turn on and off of transistors (sch, scl). The selection circuit 110 connected to each of the scan electrodes (Y) is generally installed in a form of an integrated circuit.

The first driver 102 supplies a rising ramp pulse to the scan electrodes (Y) via the selection circuit 110 during the reset period of each of the subfields. This way, a plurality of micro-discharges are generated at the discharge cells, and a wall charge is formed by the micro-discharges. For this purpose, the first driver 102 includes one transistor (Yrr), one diode (Dset) and one boosting capacitor (Cb).

The second driver 106 supplies a falling ramp pulse to the scan electrodes (Y) via the selection circuit 110 after the rising ramp pulse is supplied to the scan electrodes (Y). This way, some of the wall charges formed at the discharge cells by the rising ramp pulse are erased. When some of the wall charges formed at the discharge cells are erased by the falling ramp pulse, an unnecessarily strong discharge may be prevented from being generated. And, the second driver 106 sequentially supplies a scan pulse to the scan electrodes (Y) during the address period of each of the subfields. For this purpose, the second driver 106 includes a diode (Dsch), transistors (Ysch, Ysp, Yscan, Yfr) and a capacitor (Csch).

The energy recovery circuit 104 supplies a sustain pulse during the sustain period of each of the subfields. In practice, the energy recovery circuit 104 reduces power consumption by recovering an energy with which the panel capacitor (Cp) is charged and using the recovered energy to supply a sustain pulse. The energy recovery circuit 104 includes transistors (Yr, Yf, Ys, Yg, Ypp), diodes (Yrpass, Yfpass, D1, D2) and an inductor (L).

The conventional scan driver further includes a control transistor (Ypn) arranged (located or disposed) between the energy recovery circuit 104 and the selection circuit 110 to stably maintain a negative polar potential when the negative polar potential is supplied to the scan electrodes (Y). The control transistor (Ypn) prevents an unnecessary electrical current from flowing in the energy recovery circuit 104 since the control transistor (Ypn) is turned off when the negative polar voltage is supplied to the scan electrodes (Y), and therefore the negative polar voltage is stably supplied to the scan electrodes (Y).

Here, a rising electrical current flows in the control transistor (Ypn) when the transistor (Yr) is turned on to supply a sustain pulse; a falling electrical current flows in the control transistor (Ypn) when the transistor (Yf) is turned on to end the sustain pulse; a ground electrical current flows in the control transistor (Ypn) when the transistor (Yg) is turned on; and a sustain electrical current flows in the control transistor (Ypn) when the sustain voltage (Vs) is supplied to stably maintain the sustain pulse, as shown in FIG. 2.

However, a high amount of heat is generated in the control transistor (Ypn) when a large electrical current is supplied via the control transistor (Ypn), as shown in FIG. 2. Actually, Additional heat release systems are installed to prevent a bad effect by the generation of heat in the control transistor (Ypn). In order to prevent the control transistor (Ypn) from being damaged by the above-mentioned electrical currents, the control transistor (Ypn) is composed of a plurality of transistors, resulting in the increase in the manufacturing cost. In addition, the sustain pulse may be distorted because of the high amount of heat generated in the control transistor (Ypn) since the sustain voltage (Vs) is supplied via the control transistor (Ypn).

### SUMMARY OF THE INVENTION

An aspect of an exemplary embodiment according to the present invention is to provide a plasma display apparatus capable of reducing the number of switches (or transistors) while decreasing the generation of heat.

In one embodiment according to the present invention, a plasma display apparatus is provided. The plasma display apparatus includes: a display panel including a plurality of scan electrodes and a plurality of sustain electrodes; a selection circuit connected to a corresponding one of the scan electrodes, and adapted to selectively apply a first voltage and a second voltage to the corresponding one of the scan electrodes; an energy recovery circuit connected to a sustain voltage source for supplying a sustain voltage and the selection circuit, the energy recovery circuit being adapted to supply a sustain pulse to the scan electrodes; a first transistor for providing a voltage of an operating voltage source to the selection circuit; a second transistor for providing the sustain voltage to the selection circuit; a control transistor located between the second transistor and the first transistor, wherein the control transistor is adapted to control a flow of electrical current from the energy recovery circuit; and drivers connected to the selection circuit and adapted to supply a rising ramp signal, a falling ramp signal and a scan signal to the scan electrodes. In another embodiment, a driving circuit for the plasma display apparatus is provided.

In one embodiment, the drivers may include a first driver for supplying the rising ramp signal; and a second driver for supplying the falling ramp signal and the scan signal. The energy recovery circuit may further include a source capacitor adapted to be charged with an energy recovered from a panel capacitor formed by the scan electrodes and the sustain electrodes; a third transistor adapted to be turned on when the energy charged in the source capacitor is supplied to the panel capacitor; a fourth transistor adapted to be turned on when the energy is recovered from the panel capacitor; and an inductor for forming a resonance circuit with the panel capacitor.

### BRIEF DESCRIPTION OF THE DRAWINGS

These and/or other aspects and features of exemplary embodiments according to the present invention will become apparent and more readily appreciated from the following description of the exemplary embodiments, taken in conjunction with the accompanying drawings of which:

FIG. 1 is a circuit diagram showing a conventional scan driver.

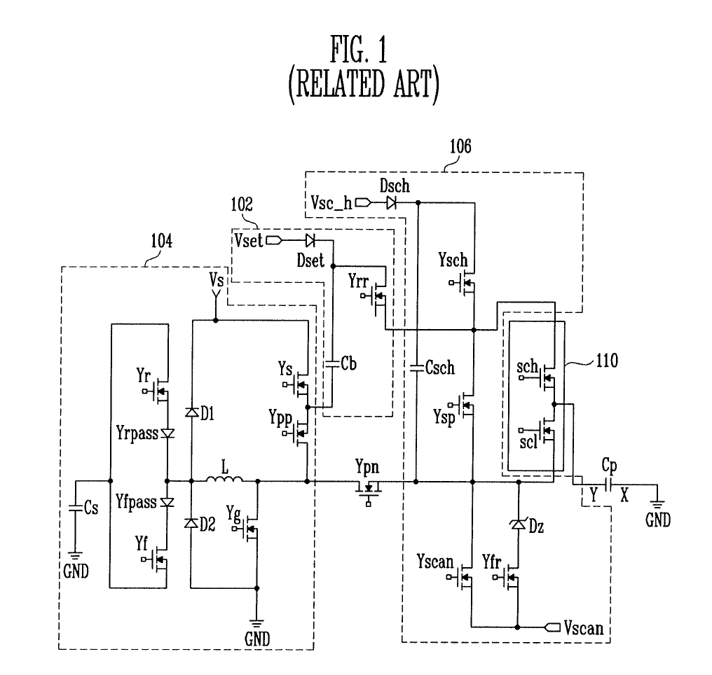

FIG. 2 is the circuit diagram of FIG. 1, in which an electrical current flows from the scan driver to a control transistor.

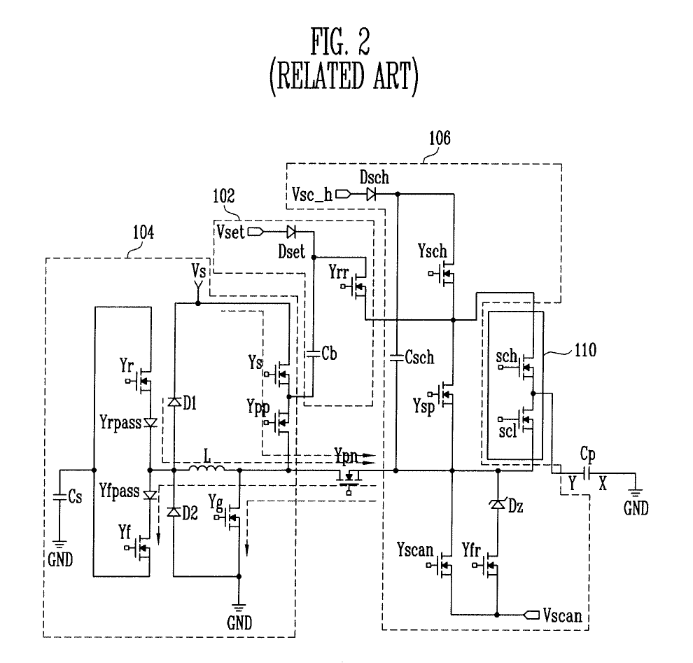

FIG. 3 is a block diagram showing a plasma display apparatus according to one embodiment of the present invention.

FIG. 4 is a diagram showing a driving waveform supplied by the scan driver of FIG. 3.

FIG. 5 is a circuit diagram showing a scan driver according to a first embodiment of the present invention.

FIG. 6 is the circuit diagram of FIG. 5, in which an electrical current flows from the scan driver to a control transistor.

### DETAILED DESCRIPTION OF EXEMPLARY EMBODIMENTS

Hereinafter, exemplary embodiments according to the present invention will be described with reference to the accompanying drawings. Here, when one element is described as being connected to another element, one element may be directly connected to another element, or may be indirectly connected to another element via a third element. Further, some of the elements that are not essential to the complete understanding of the exemplary embodiments are omitted for clarity. Also, like reference numerals refer to like elements throughout.

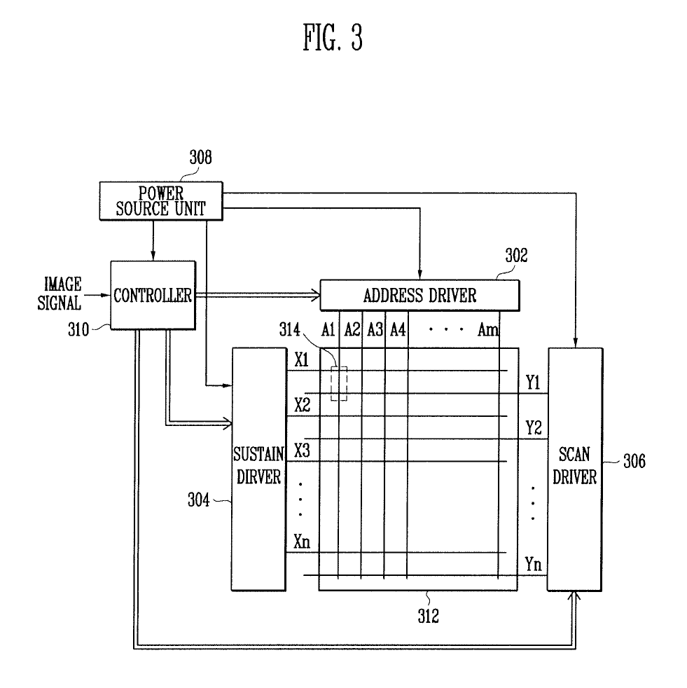

FIG. 3 is a diagram showing a plasma display apparatus according to one embodiment of the present invention.

Referring to FIG. 3, the plasma display apparatus according to one embodiment of the present invention includes a display panel (or plasma display panel) 312, an address driver 302, a sustain driver 304, a scan driver 306, a power source unit 308 and a controller 310.

The display panel 312 includes scan electrodes (Y1 to Yn) and sustain electrodes (X1 to Xn) formed in parallel with each other; and address electrodes (A1 to Am) formed in a direction crossing the scan electrodes (Y1 to Yn). Here, discharge cells 314 are arranged at regions in which the scan electrodes (Y1 to Yn), the sustain electrodes (X1 to Xn) and the address electrodes (A1 to Am) cross each other. Accordingly, in one embodiment of the present invention, each discharge cell 314 is formed at a region where the Y, X and A electrodes cross, but the present invention is not limited thereto.

The controller 310 receives an image signal from the outside to generate control signals for controlling an address driver 302, a sustain driver 304 and a scan driver 306. Here, the controller 310 generates control signals so that one frame can be divided into a plurality of subfields, each subfield having a reset period, an address period and a sustain period. The subfields are driven to generate an image for the frame.

The address driver 302 selects discharge cells 314 to be turned on by supplying a data pulse (i.e., a data signal) corresponding to the control signal supplied from the controller 310, to the address electrodes (A1 to Am) during the address period of each of the subfields.

The sustain driver 304 supplies a sustain pulse corresponding to the control signal supplied from the controller 310, to the sustain electrodes (X1 to Xn) during the sustain period of each of the subfields.

The scan driver 306 controls a driving waveform, supplied to the scan electrodes (Y1 to Yn), according to the control signal supplied from the controller 310. The scan driver 306 supplies a ramp pulse (i.e., a ramp signal) to the scan electrodes (Y1 to Yn) during the reset period of each of the subfields, and sequentially supplies a scan pulse (i.e., a scan signal) during the address period of each of the subfields. Also, the scan driver 306 supplies a sustain pulse to the scan electrodes (Y1 to Yn) alternately with the sustain pulse being provided to the sustain electrodes (X1 to Xn) during the sustain period of each of the subfields.

The power source unit 308 supplies a power source, required for driving a plasma display apparatus, to the controller 310 and the drivers 302, 304, 306.

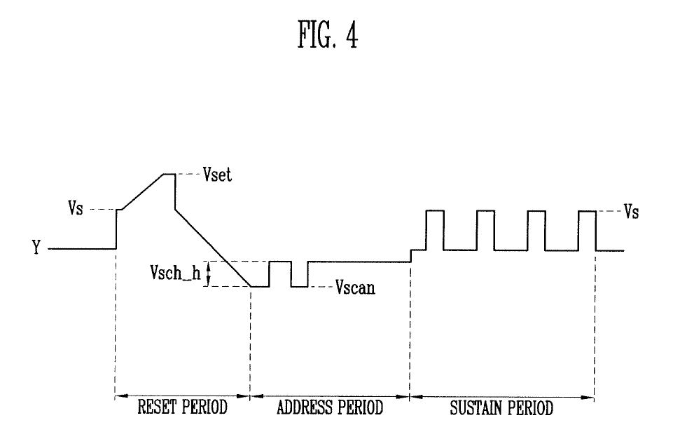

FIG. 4 is a waveform diagram showing a driving waveform supplied from the scan driver 306 of FIG. 3.

Referring to FIG. 4, the scan driver 306 supplies a rising ramp pulse (i.e., a rising ramp signal) and a falling ramp pulse (i.e., a falling ramp signal) to the scan electrodes (Y) during the reset period. A wall charge is formed since a micro-discharge is generated at the discharge cells 314 when the rising ramp pulse is supplied to the scan electrodes (Y). Some of wall charges, generated at the discharge cells 314 by the rising ramp pulse, are erased when the falling ramp pulse is supplied to the scan electrodes (Y). A strong discharge may be prevented from being generated at the discharge cells 314 during the address period if some of the wall charges, generated at the discharge cells 314, are erased by the falling ramp pulse.

The scan driver 306 sequentially supplies a scan pulse (i.e., a scan signal) to the scan electrodes (Y) during the address period. At this time, the address driver 302 supplies a data pulse (i.e., a data signal) to the address electrodes (A1 to Am) to correspond to gray levels to be displayed. Then, an address discharge is generated at the discharge cells 314 to which the data pulse is supplied, as the wall voltage generated during the reset period is added to a voltage difference between the scan pulse and the data pulse. A wall charge required for the sustain discharge is formed at the discharge cells 314 in which the address discharge is generated.

The scan driver 306 supplies sustain pulses to the scan electrodes (Y) during the sustain period. At this time, as those skilled in the art would appreciate, the sustain driver 304 supplies sustain pulses to the sustain electrodes (X) alternately with the sustain pulses supplied to the scan electrodes (Y). Then, a sustain discharge is generated, as a voltage of the sustain pulse is added to the wall voltage in the discharge cell 314 selected by the address discharge. Here, the number of the sustain discharges is determined according to the number of the supplied sustain pulses.

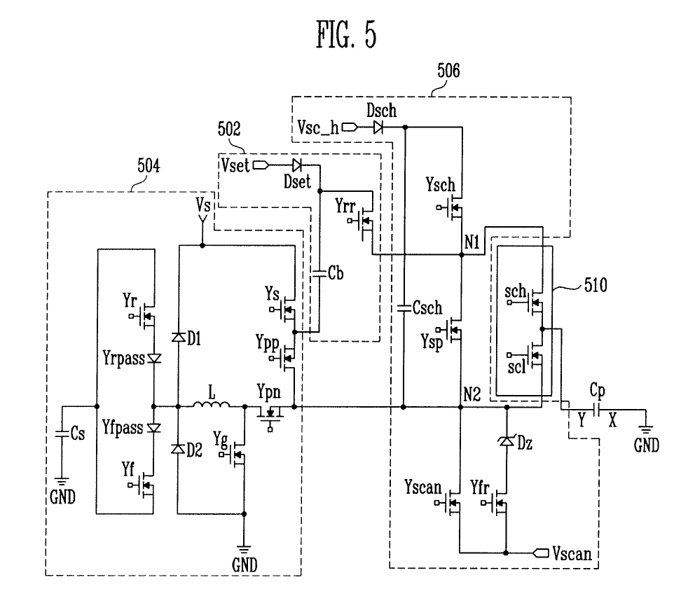

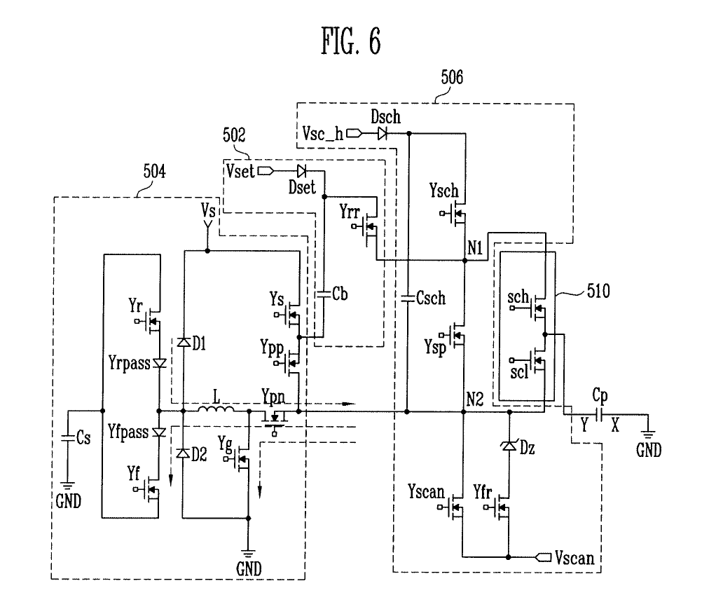

FIG. 5 is a diagram showing a scan driver according to a first embodiment of the present invention. The panel capacitor (Cp) equivalently represents capacitive components formed by the scan electrodes (Y) and the sustain electrodes (X), as shown in FIG. 5. Also, while the sustain electrode (X) is connected with the sustain driver 304 (shown in FIG. 3), in FIG. 5, the sustain electrode (X) is illustrated as being connected with a ground voltage source (GND) for convenience of description. Further, while only one Y electrode and only one X electrode is shown in FIG. 5, as shown in FIG. 3, the scan driver is coupled to a plurality of Y electrodes via respective selection circuits, and the sustain driver is coupled to a plurality of X electrodes. Further, while only one selection circuit 510 is shown in FIGS. 5 and 6, the selection circuit includes a plurality of selection circuits, each of which is coupled to a corresponding one of the scan electrodes. The selection circuits may be implemented in an integrated circuit, for example.

Referring to FIG. 5, the scan driver 306 according to the first embodiment of the present invention includes a selection circuit 510 (one of the selection circuits) coupled to a respective one of the scan electrodes (Y); a first driver 502 for supplying a rising ramp pulse (i.e., a rising ramp signal); a second driver 506 for supplying a falling ramp pulse (i.e., a falling ramp signal) and a scan pulse (i.e., a scan signal); and an energy recovery circuit 504 for recovering and re-supplying an energy of the panel capacitor (Cp).

While only one selection circuit 510 is shown in FIG. 5, the scan driver 306 includes a plurality of selection circuits, each selection circuit 510 being connected to a corresponding one of the scan electrodes (Y). The selection circuit 510 selectively supplies voltages, a first voltage supplied to a first node (N1) (or a first end) and a second voltage supplied to a second node (N2) (or a second end), to the scan electrodes (Y) while it controls turn on and off of transistors (sch, scl).

The first driver 502 supplies the rising ramp pulse to the scan electrodes (Y) via the selection circuit 510 during the reset period of each of the subfields. For this purpose, the first driver 502 includes a transistor (Yrr), a diode (Dset) and a boosting capacitor (Cb).

One end of the boosting capacitor (Cb) is connected to the energy recovery circuit 504, and its other end is connected to the diode (Dset). The boosting capacitor (Cb) receives the sustain voltage (Vs) from the energy recovery circuit 504 during the reset period. Accordingly, the rising reset voltage (Vset), supplied during the reset period, is supplied with a higher level than the sustain voltage (Vs). The diode (Dset) prevents a reverse current from flowing.

The transistor (Yrr) is turned on during a period of the reset period when the rising ramp pulse is supplied.

The second driver 506 supplies a falling ramp pulse to the scan electrodes (Y) via the selection circuit 510 after the rising ramp pulse is supplied to the scan electrode (Y). Also, the second driver 506 sequentially supplies a scan pulse to the scan electrodes (Y) during the address period of each of the subfields. For this purpose, the second driver 506 includes a diode (Dsch), transistors (Ysch, Ysp, Yscan, Yfr), a capacitor (Csch) and a Zener diode (Dz).

The transistors (Yfr, scl) are turned on when the falling ramp pulse is supplied to the scan electrodes (Y). Then, a voltage of the scan electrode (Y) slowly falls to a second scan voltage (Vscan).

The transistors (Yscan, Ysch) are turned on during the address period. Then, a first scan voltage (Vsc_h) is applied to the first node (N1), and a second scan voltage (Vscan) is applied to the second node (N2). Here, one voltage out of the first scan voltage (Vsc_h) and the second scan voltage (Vscan) is supplied to the scan electrodes (Y) to correspond to the operation of the transistors (sch, scl) in the selection circuit 510. The control transistor (Ypn) is maintained in a turned-off state during a period when the second driver 506 is driven to supply the falling ramp pulse, and during the address period.

The energy recovery circuit 504 supplies a sustain pulse during the sustain period of each of the subfields. Here, the energy recovery circuit 504 reduces power consumption by recovering an energy with which the panel capacitor (Cp) is charged and using the recovered energy to supply a sustain pulse. The energy recovery circuit 504 includes transistors (Yr, Yf, Ys, Ypp, Yg), diodes (D1, D2, Yrpass, Yfpass), an inductor (L) and a source capacitor (Cs).

The source capacitor (Cs) recovers an energy from the panel capacitor (Cp), and then is charged with a voltage during the sustain period, and re-supplies the charged voltage to the panel capacitor (Cp). For this purpose, the source capacitor (Cs) has a capacity that can be charged with a voltage corresponding to a half of the sustain voltage (Vs), i.e., Vs/2.

The inductor (L) is arranged between the source capacitor (Cs) and the panel capacitor (Cp). The inductor (L) forms a resonance circuit with the panel capacitor (Cp). Accordingly, the voltage, supplied from the source capacitor (Cs) to the panel capacitor (Cp), rises to approximately the sustain voltage (Vs).

The third transistor (Yr) is arranged between the inductor (L) and the source capacitor (Cs). The third transistor (Yr) is turned on when a voltage is supplied from the source capacitor (Cs) to the panel capacitor (Cp).

The fourth transistor (Yf) is arranged between the inductor (L) and the source capacitor (Cs). The fourth transistor (Yf) is turned on when an energy is recovered from the panel capacitor (Cp) by the source capacitor (Cs).

The fifth transistor (Ys) and the second transistor (Ypp) are arranged between the sustain voltage (Vs) and the panel capacitor (Cp). The fifth transistor (Ys) and the second transistor (Ypp) are turned on after a voltage is primarily supplied from the source capacitor (Cs) to the panel capacitor (Cp). Here, a sustain discharge may be stably generated since the sustain voltage (Vs) is supplied to the panel capacitor (Cp).

The first transistor (Yg) is arranged between the ground voltage source (GND) and the panel capacitor (Cp). The first transistor (Yg) is turned on when a ground potential is supplied to the panel capacitor (Cp).

The control transistor (Ypn) is arranged (located or disposed) between the second transistor (Ypp) and the first transistor (Yg). The control transistor (Ypn) is turned off to prevent a flow of unnecessary electrical current when a negative polar potential is supplied to the second node (N2), and therefore a potential of the second node (N2) is stably maintained with a negative polarity.

When the control transistor (Ypn) is arranged between the second transistor (Ypp) and the first transistor (Yg) as described herein, then a rising electrical current flows in the control transistor (Ypn) at a time point when the third transistor (Yr) is turned on to supply a sustain pulse; a falling electrical current flows in the control transistor (Ypn) at a time point when fourth transistor (Yf) is turned on to end a sustain pulse; only a ground electrical current flows in the control transistor (Ypn) when the first transistor (Yg) is turned on, as shown in FIG. 6. That is to say, a sustain electrical current caused by the sustain voltage (Vs) does not flow in the control transistor (Ypn) in the described embodiment of the present invention, unlike the case of the conventional control transistors.

Here, a rising electrical current flows in the control transistor (Ypn) at a time point when the transistor (Yr) is turned on to supply a sustain pulse; a falling electrical current flows in the control transistor (Ypn) at a time point when the transistor (Yf) is turned on to end a sustain pulse; a ground electrical current flows in the control transistor (Ypn) when the transistor (Yg) is turned on; and a sustain electrical current flows in the control transistor (Ypn) when the sustain voltage (Vs) is supplied to stably maintain the sustain pulse

Therefore, the number of the control transistors (Ypn) may be reduced since the generation of heat may be reduced in the control transistor (Ypn). Also, a size of a board to which the drive circuit is added may be reduced by improving heat release if the generation of heat is reduced in the control transistor (Ypn). In addition, distortion of the sustain pulse may be prevented since the sustain voltage (Vs) is supplied to the panel capacitor (Cp) without passing through the control transistor (Ypn).

As described above, the plasma display apparatus according to the embodiment of the present invention can prevent or reduce the generation of heat in the control transistor by positioning the control transistor to interrupt a sustain electrical current from flowing, resulting in reduction in the manufacturing cost. Also, the distortion of the sustain pulse may be prevented in exemplary embodiments according to the present invention since the sustain voltage is supplied to the panel capacitor without passing through the control transistor.

The exemplary embodiment described herein is one example for the purpose of illustrations only, and is not intended to limit the scope of the invention, so it should be understood that other equivalents and modifications could be made thereto without departing from the spirit and scope of the present invention as those skilled in the art would appreciate. Therefore, it should be understood that the present invention is not limited in scope to what is described in detailed description, but the scope is defined in the claims and their equivalents.

What is claimed is:

1. A plasma display apparatus comprising:
a display panel comprising a plurality of scan electrodes and a plurality of sustain electrodes;
a selection circuit connected to a corresponding one of the scan electrodes, and adapted to selectively apply a first voltage and a second voltage to the corresponding one of the scan electrodes;
an energy recovery circuit connected to a sustain voltage source for supplying a sustain voltage and the selection circuit, the energy recovery circuit being adapted to supply a sustain pulse to the scan electrodes, and comprising:
a first transistor for providing a voltage of an operating voltage source to the selection circuit; and
a second transistor for providing the sustain voltage to the selection circuit;
a control transistor located between the second transistor and the first transistor, wherein the control transistor is adapted to control a flow of electrical current from the energy recovery circuit; and
drivers connected to the selection circuit and adapted to supply a rising ramp signal, a falling ramp signal and a scan signal to the scan electrodes.

2. The plasma display apparatus according to claim 1, wherein the drivers comprise:
a first driver for supplying the rising ramp signal; and
a second driver for supplying the falling ramp signal and the scan signal.

3. The plasma display apparatus of claim 2, wherein the control transistor is adapted to control the flow of electrical current from the energy recovery circuit toward a connecting point between the selection circuit and the second driver.

4. The plasma display apparatus according to claim 1, wherein the energy recovery circuit comprises:
a source capacitor adapted to be charged with an energy recovered from a panel capacitor formed by the scan electrodes and the sustain electrodes;
a third transistor adapted to be turned on when the energy charged in the source capacitor is supplied to the panel capacitor;
a fourth transistor adapted to be turned on when the energy is recovered from the panel capacitor; and
an inductor for forming a resonance circuit with the panel capacitor.

5. The plasma display apparatus of claim 1, wherein the voltage of the operating voltage source is a ground voltage.

6. The plasma display apparatus of claim 1, wherein the first voltage comprises the rising ramp signal, and the second voltage comprises at least one of the falling ramp signal or the scan signal.

7. The plasma display apparatus of claim 1, wherein the selection circuit comprises first and second transistors coupled in series between a first end and a second end of the selection circuit, wherein the first end is configured to receive the first voltage and the second end is configured to receive the second voltage, and wherein a connecting point between the first and second transistors is coupled to the corresponding one of the scan electrodes.

8. The plasma display apparatus of claim 1, wherein the second transistor and the control transistor are arranged with respect to each other such that the second transistor is adapted to provide the sustain voltage to the selection circuit without the sustain voltage passing through the control transistor.

9. A driving circuit for a plasma display apparatus comprising a display panel having a plurality of scan electrodes and a plurality of sustain electrodes, the driving circuit comprises:
a selection circuit connected to a corresponding one of the scan electrodes, and adapted to selectively apply a first voltage and a second voltage to the corresponding one of the scan electrodes;
an energy recovery circuit connected to a sustain voltage source for supplying a sustain voltage and the selection circuit, the energy recovery circuit being adapted to supply a sustain pulse to the scan electrodes, and comprising:
a first transistor for providing a voltage of an operating voltage source to the selection circuit;
a second transistor for providing the sustain voltage to the selection circuit; and
a control transistor located between the second transistor and the first transistor, wherein the control transistor is adapted to control a flow of electrical current from the energy recovery circuit; and
drivers connected to the selection circuit and adapted to supply a rising ramp signal, a falling ramp signal and a scan signal to the scan electrodes.

10. The driving circuit according to claim 9, wherein the drivers comprise:
a first driver for supplying the rising ramp signal; and
a second driver for supplying the falling ramp signal and the scan signal.

11. The driving circuit according to claim 9, wherein the energy recovery circuit further comprises:
a source capacitor adapted to be charged with an energy recovered from a panel capacitor formed by the scan electrodes and the sustain electrodes;
a third transistor adapted to be turned on when the energy charged in the source capacitor is supplied to the panel capacitor;
a fourth transistor adapted to be turned on when the energy is recovered from the panel capacitor; and
an inductor for forming a resonance circuit with the panel capacitor.

12. The driving circuit according to claim 9, wherein the voltage of the operating voltage source is a ground voltage.
